(19) United States
(12) Patent Application Publication
(10) Pub. No.: US 2015/0107123 A1
(43) Pub. Date: Apr. 23, 2015

(54) Hand-Guided Jig Saw

(71) Applicant: Robert Bosch GmbH, Stuttgart (DE)

(72) Inventors: Nicolas Klotz, Niefern-Oeschelbronn (DE); Ulli Hoffmann, Niefern-Oeschelbronn (DE)

(21) Appl. No.: 14/516,715

(22) Filed: Oct. 17, 2014

(30) Foreign Application Priority Data
Oct. 17, 2013 (DE) 10 2013 221 092.2

(51) Int. Cl. B23D 49/16

(52) U.S. Cl. CPC B23D 49/167
USPC 30/392

(57) ABSTRACT

A hand-guided jig saw includes a tool housing that houses a drive motor. The drive motor is configured to drive a reciprocating transmission that drives a reciprocating unit connected to a tool receptacle. A vertical axis of the tool receptacle saw is configured to receive a saw blade. In order to enable at least partial free cutting of the saw blade for forming a sawing passage in a workpiece, the tool receptacle, via an electromechanical actuating system, is pivotable by a pre-defined angle about a vertical axis. A pivoting movement of the saw blade is superimposed by at least a reciprocating movement of the tool receptacle.

This application claims priority under 35 U.S.C. §119 to patent application no. DE 10 2013 221 092.2, filed on Oct. 17, 2013 in Germany, the disclosure of which is incorporated herein by reference in its entirety.

The present disclosure relates to a hand-guided jig saw having a tool housing in which a drive motor is disposed for driving a reciprocating transmission which is configured at least for the reciprocating drive of a reciprocating unit which is connected to a tool receptacle, configuring a vertical axis, for receiving a saw blade.

### BACKGROUND

From the prior art, a hand-guided jig saw of this type, which is configured in the manner of a so-called “semi-autonomous” jig saw, having an assigned tool receptacle for a saw blade is known. The tool receptacle is configured so as to be pivotable about its vertical axis by means of a servomotor, wherein the servomotor is activated, for example, using signals of an optoelectronic system which acquires the profile of a pre-drawn marking line on an assigned workpiece. On account thereof, the saw blade can always correspondingly align itself in a semi-autonomous manner, that is to say in a self-acting manner, to the profile of the marking line such that a corresponding saw cut can be performed by a user more easily and with higher precision. The saw blade here may display a tooth geometry which is produced by milling and subsequent hardening, wherein the teeth of the saw blade are additionally set in order to avoid sticking of the saw blade in the sawing passage during free cutting with the saw blade for configuring a sawing passage.

It is disadvantageous in the prior art that a free cutting of the saw blade which is necessary for the free-moving and precise sawing of a corresponding sawing passage cannot be realized independently of the presence of a setting of the teeth of said saw blade. Moreover, a corresponding free-cutting effect of the set teeth is reduced due to wear after a comparatively long period of usage of the saw blade, which is disadvantageously evident in particular when sawing curves.

### SUMMARY

It is, therefore, an object of the disclosure to provide a new hand-guided jig saw, in particular a new semi-automatic jig saw, in which at least jamming of an assigned saw blade in a sawing passage to be sawn by said saw blade can be at least largely avoided, independently of the presence of a setting of corresponding teeth of the saw blade.

This object is achieved by a hand-guided jig saw having a tool housing in which a drive motor is disposed for driving a reciprocating transmission which is configured at least for the reciprocating drive of a reciprocating unit which is connected to a tool receptacle, configuring a vertical axis, for receiving a saw blade. For at least partial free cutting of the saw blade for configuring a sawing passage, the tool receptacle, by means of an electromechanical actuating system, is pivotable by a pre-defined angle about its vertical axis, wherein the pivoting movement of the saw blade is superimposed by at least the reciprocating movement of the latter.

The disclosure thus enables the provision of a hand-guided jig saw in which, on account of pivoting movements of the saw blade about its vertical axis in an assigned sawing passage, free cutting of said saw blade in the sawing passage is possible, independently of the setting of said saw blade.

According to one embodiment, the electromechanical actuating system is configured for generating a symmetrically oscillating pivoting movement of the saw blade.

On account of the preferably periodic pivoting movement, a uniform free-cutting process is ensured, and sticking and/or jamming of the saw blade in the sawing passage can be at least largely prevented.

Additionally or alternatively thereto, the electromechanical actuating system is moreover preferably configured for generating an asymmetrically oscillating pivoting movement of the saw blade.

In relation to a cross axis running centrically through the toothed side and a saw-blade rear side of the preferably pivotable saw blade, and to a longitudinal axis of the jig saw (x-axis) as a reference axis, pivot angles α₁,α₂ on both sides of the cross axis may in each case be of same size or be of different sizes, wherein at all times the correlation α=α₁+α₂ applies.

According to one embodiment, the pre-defined angle is variable, depending on a local amount of curvature of the sawing passage to be produced.

On account thereof, the pre-defined angle may be reduced to almost zero in straight portions of the sawing passage, and increased in more heavily curved portions of the sawing passage.

According to one refinement, the pre-defined angle is pre-selectable, depending on a material of a workpiece to be worked.

On account thereof, inhomogeneities in a workpiece to be sawed, such as, for example, changes in the material thickness, variations of density, knotholes, changes of materials, etc., and transverse forces acting on the saw blade on account thereof can be at least partly compensated for by a corresponding adjustment of the pre-defined angle.

According to one refinement, the pre-defined angle is pre-selectable, depending on a feeding rate of the saw blade.

On account thereof, the size of the pre-defined angle can be adapted to the feeding rate of the saw blade in the material. Preferably, the size of the pre-defined angle is correspondingly reduced as the feeding rate increases.

In accordance with one design embodiment, a frequency of the pivoting movement is pre-selectable.

On account thereof, a further parameter for the adjustment of the pre-defined angle is made available.

In accordance with one embodiment, the electromechanical actuating system displays an electric servomotor for pivoting the tool receptacle about its vertical axis.

On account thereof, the size of the pre-defined angle can be pre-defined and governed by an electronic control unit. Moreover, adequately high activating forces with a high positioning precision can be achieved with a servomotor.

In the case of a further design embodiment, the saw blade displays set teeth.

On account thereof, the sawing passage may also be cut free, independently of the oscillating pivoting movement of the saw blade about its vertical axis in the sawing passage.

According to a further embodiment, the jig saw is a semi-autonomous jig saw in which the tool receptacle, reacting to a signal of an optoelectronic system, is pivotable by means of the electromechanical actuating system about its vertical axis within an angular range, for aligning the saw blade in a self-acting manner when sawing along a pre-drawn marking line, wherein this pivoting which is based on an assigned profile of the sawing passage is superimposed on the oscillating pivoting movement for free cutting of the saw blade.

On account thereof, the sensor system and actuating system, which are anyway present in the case of a semi-autonomous jig saw, can be conjointly utilized.

### BRIEF DESCRIPTION OF THE DRAWINGS

The disclosure is described in more detail by means of exemplary embodiments illustrated in the drawings in the following description. In the drawings:

FIG. 1 shows a perspective view of a jig saw which is configured in the manner of a hand-guided, semi-autonomous jig saw;

FIG. 2 shows a schematic view of a workpiece having a sawing passage and two symmetrical pivoting positions of the saw blade of the jig saw from FIG. 1;

FIG. 3 shows a schematic view of a workpiece having a sawing passage and asymmetrical pivoting positions of the saw blade of the jig saw from FIG. 1; and

FIG. 4 shows a front view of the sawing passage from FIG. 2, produced by means of the jig saw from FIG. 1 in a workpiece.

### DETAILED DESCRIPTION

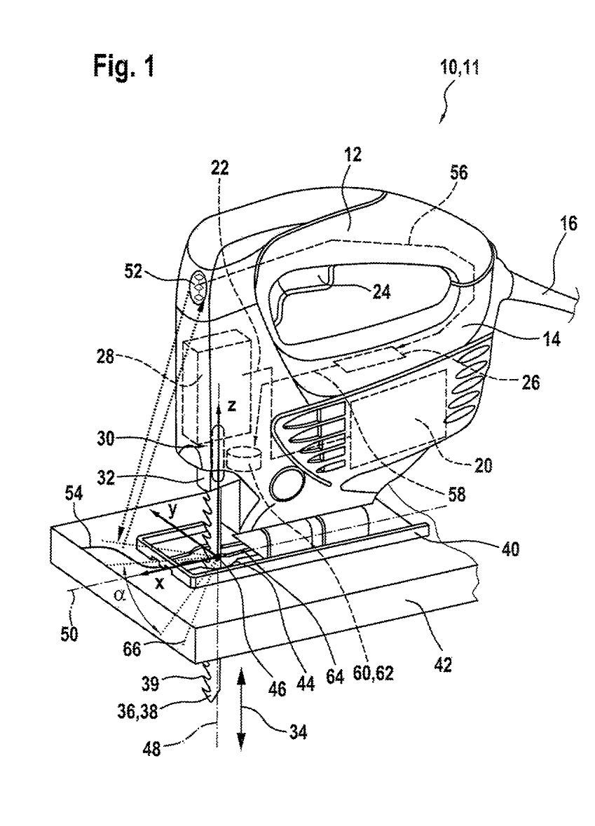

FIG. 1 shows a hand-guided jig saw 10 which, in an exemplary manner, is configured in the manner of a semi-autonomous, hand-guided jig saw 11, and displays a tool housing 14 which is provided with a handle-type handgrip 12. The semi-autonomous jig saw 11, for the mains-dependent power supply, is preferably equipped with a flexible electrical connection line 16. It should be pointed out, however, that the present disclosure is not to be considered as being limited to a hand-guided semi-autonomous jig saw 11 which is operable in a mains-dependent manner, but rather may be applied also to jig saws of all types which are operable in a mains-independent manner and which, for their power supply, are mechanically and electrically connectable to an assigned rechargeable battery back, for example. It is moreover pointed out that the present disclosure is also not limited to jig saws having tool housings which configure handle-type handgrips, but may also be applied to jig saws having bar-shaped tool housings.

In the tool housing 14, a drive motor 20 for driving a drive shaft 22 is disposed in an exemplary manner. The drive motor 20 is actuatable, that is to say that it can at least be switched on and off, by a user, for example by way of a hand switch 24 or a hand button, and may be any type of motor, for example an electronically commutated motor or a DC motor. The drive motor 20 is preferably electronically controllable and/or regulatable in such a manner by way of an electronic control unit 26, that parameters with respect to a desired rotation speed of the drive shaft 22 are implementable, for example. On account thereof, a respective revolution of the drive motor 20, and conjointly therewith, a corresponding sawing speed and/or a feeding rate of the jig saw 11 inter alia can be easily adapted to variable workpiece properties. The operating mode and the construction of a drive motor 20 of such type and of the electronic control unit 26 are sufficiently known to a person skilled in the art from the prior art, so that a detailed description thereof is dispensed with here in the interest of brevity of the description.

The drive shaft 22 is mechanically coupled to a reciprocating transmission 28 for driving a reciprocating unit 30 which, in an exemplary manner, displays and/or is fixedly connected to a tool receptacle 32 for clamping an insert tool 36 which, by means of the reciprocating transmission 28, is drivable in a reciprocating manner substantially in the direction of a double arrow 34. The insert tool 36 here is configured in a merely exemplary manner as a saw blade 38 having a multiplicity of optionally set saw teeth, wherein merely one tooth, representing all other teeth, is provided with the reference sign 39. Here, the saw blade 38 runs perpendicularly to a foot plate 40 which is fastened on the tool housing 14 and with which the hand-guided, semi-autonomous jig saw 11 bears on and/or is guidable on an exemplary planar workpiece 42. Here, the saw blade 38, proceeding from the tool receptacle 32, in an illustrative manner, engages, through a clearance 44 provided in the foot plate 40, onto the workpiece 42.

The tool receptacle 32, in an illustrative manner, has a vertical axis 48 which, in an exemplary manner, coincides with a z-axis of a coordinate system 46, while an x-axis of the coordinate system 46, in an illustrative manner, runs parallel to a longitudinal axis 50 of the jig saw 11 and/or the tool housing 14. Moreover, in deviation from the shown perpendicular alignment of the saw blade 38 in relation to the workpiece 42, the foot plate 40 may be adjusted to an angle in relation to the vertical axis 48 which deviates from 90°, for example in order to also implement inclined sawing cuts in a simple way and manner.

In the tool housing 14, in an exemplary manner, above the reciprocating transmission 28, an optoelectronic system 52, by means of which a profile of a pre-drawn marking line 54 on the workpiece 42 can be acquired in a non-contacting manner with high precision, for example with the aid of an optical sensing system or similar which is disposed on a front side, is integrated. A signal 56 generated by the optoelectronic system 52 is preferably supplied at least to the electronic control unit 26. In this electronic, preferably digital control unit 26, an evaluation and processing of the signal 56, emanating from the optoelectronic system 52, into an output signal 58 which is preferably suitable for the direct activation of a servomotor 60 of an electromechanical actuating system 62, can take place The electromechanical actuating system 62 and/or the servomotor 60 in turn are mechanically coupled to the tool receptacle 32, such that the latter together with the saw blade 38 clamped therein, governed by the control unit 26, can be conjointly pivoted about the vertical axis 48 and/or the z-axis of the coordinate system 46. On account thereof, it is possible in the semi-autonomous sawing operation to have the saw blade 38 continuously follow the profile of the pre-drawn marking line 54 with high precision, in each case depending on the signal 56 of the optoelectronic system 52, such that a sawing passage 64 in the workpiece 42, produced by means of the jig saw 11, always corresponds with high precision to the pre-defined profile of the marking line 54. On account thereof, even users with little practice can introduce the sawing passage 64 with high precision and/or dimensional accuracy into the workpiece 42.

According to one embodiment, for free cutting of the saw blade 38, a rapid, periodically oscillating pivoting movement of the tool receptacle 32 about the vertical axis 48 is superimposed on a tracking movement of the saw blade 38, which takes place slowly, in the semi-autonomous sawing operation. This pivoting movement of the tool receptacle 32 and/or the saw blade 38, which serves for free cutting of the saw blade 38, is preferably generated with the aid of the electromechanical actuating system 62 and/or by way of the electric servomotor 60, such that, at least in the case of the semi-autonomous, hand-guided jig saw 11 which is shown here, no additional constructive investment is required.

For free cutting of the saw blade 38, pivoting of the tool receptacle 32 and/or of the saw blade 38 about the vertical axis 48 preferably takes place by a pre-defined angle α within an angular range 66 in the shape of a circular sector. The pre-defined angle α here, governed by the electronic control unit 26, may be varied in many ways and in a corresponding manner to the respective application scenario of the jig saw 10 and/or the semi-autonomous jig saw 11. For example, the angle α, governed by the control unit 26, may be varied in a portion-wise manner along the sawing passage 64 on account of a profile of the marking line 54 which has been acquired by the optoelectronic system 52, depending on the local amount of curvature of the sawing passage 64. In this manner, the saw blade 38 may be pivoted by a small angle α in largely linear portions of the sawing passage 64 and/or the marking line 54 for example, or the pivoting movement which serves for free cutting is completely suspended. In contrast thereto, a larger value for the angle α may be pre-defined in a self-acting manner by the control unit 26 in those portions of the sawing passage 64 and/or the marking line 54 which display small radii of curvature.

A user of the semi-autonomous jig saw 11 may moreover manually pre-define by way of the control unit 26 a respective material texture of a workpiece 42 to be sawn and/or a desired frequency of the pivoting movement, such that the control unit 26, by means of these parameters, can determine the in each case preferred optimal angle α for the pivoting of the tool receptacle 32 which is required for free cutting. Alternatively, these parameters may also be pre-defined in a self-acting manner by the electronic control unit 26. The term, material texture of the workpiece 42, in the context of this description defines the material-specific parameters of said workpiece 42, such as, in particular, material thickness, local variations of density, inhomogeneities, such as, for example, knotholes or inclusions of resin, local changes in material, etc.

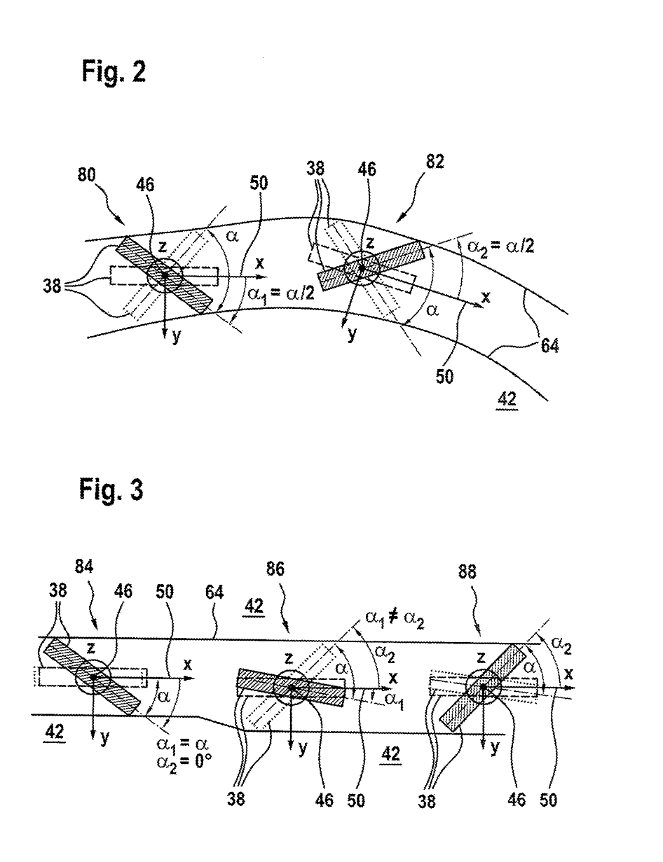

The control unit 26 may preferably furthermore dynamically determine a respective instantaneous feeding rate of the saw blade 38, for example likewise by means of the signal 56 emitted by the optoelectronic system 52, and correspondingly adjust and/or adapt the pre-defined angle α, in order to achieve preferably optimal work results. Moreover, the oscillating pivoting movement of the saw blade 38 and/or of the tool receptacle 32 may take place symmetrically in relation to the longitudinal axis 50 and/or to the x-axis of the coordinate system 46, or asymmetrically to the latter, as is described in the case of FIGS. 2 and 3.

FIG. 2 shows the workpiece 42 with a portion of the sawing passage 64 from FIG. 1, and, in an exemplary manner, two symmetrical pivoting positions 80, 82 of the saw blade 38 of the semi-autonomous jig saw 11 from FIG. 1. The depicted portion of the sawing passage 64, in an illustrative manner, at least in portions runs with a slight curvature.

In the operation of the semi-autonomous jig saw 11 from FIG. 1, the saw blade 38, preferably by means of the electromechanical actuating system (62 in FIG. 1) of the former, is in each case on both sides of the x-axis of the coordinate system 46 and/or the longitudinal axis 50 from FIG. 1, alternatingly brought into one of the two pivoting positions 80, 82 by an angle α₁, α₂, and on account thereof, cut free, wherein the angles α₁, α₂ in the attained pivoting positions 80, 82 here merely conform in an exemplary manner to the correlation α₁=α/2 and α₂=α/2, so that this is a symmetrically oscillating pivoting movement of the saw blade 38. An unpivoted rest position of the saw blade 38, which is assigned to each pivoting position 80 and/or 82, is in each case indicated by a dashed line, while the in each case other pivoting position 82 and/or 80 is in each case visualized by a dotted line.

On account of the active free-cutting according to the disclosure by way of periodically oscillating pivoting movements of the saw blade 38, jamming of the latter in the sawing passage 64 is prevented. Moreover, the active free-cutting enables in particular the more pronounced so-called “inward turning” of the saw blade 38 in portions of the sawing passage 64 which have more curvature. On account of the symmetrical pivoting movement of the saw blade 38, which here takes place merely in an exemplary manner, said saw blade 38 is released on both sides in the sawing passage 64. An absolute value of the pre-defined angle α here may be up to 120°, but preferably is at most 90°.

FIG. 3 shows the workpiece 42 with a portion of the sawing passage 64 from FIG. 1, and three exemplary asymmetrical pivoting positions 84 to 86 of the saw blade 38 of the semi-autonomous jig saw 11 from FIG. 1. As in FIG. 2, an unpivoted rest position of the saw blade 38, which is assigned to each of the pivoting positions 84 to 86, is in each case symbolized by a dashed line here as well, and an in each case previous position of the saw blade 38 is in each case illustrated by a dotted line.

In order to attain the pivoting position 84, in the operation of the semi-autonomous jig saw 11 from FIG. 1, the saw blade 38 in the sawing passage 64 is preferably merely pivoted to one side in a periodically oscillating manner by the angle α₁ in relation to the x-axis of the coordinate system 46 from FIG. 1, such that the second angle α₂ is always 0°. In the case of the other two pivoting positions 86, 88, in turn a periodically oscillating pivoting movement of the saw blade 38 in relation to the x-axis of the coordinate system 46 and/or the longitudinal axis 50 of the jig saw on both sides takes place. However, said pivoting movements take place with variably large (part-) angles α₁ and α₂, so that α₁≠α₂ applies, wherein however neither α₁ nor α₂ occupies a value of 0°, so that this is an asymmetrically oscillating pivoting movement of the saw blade 38.

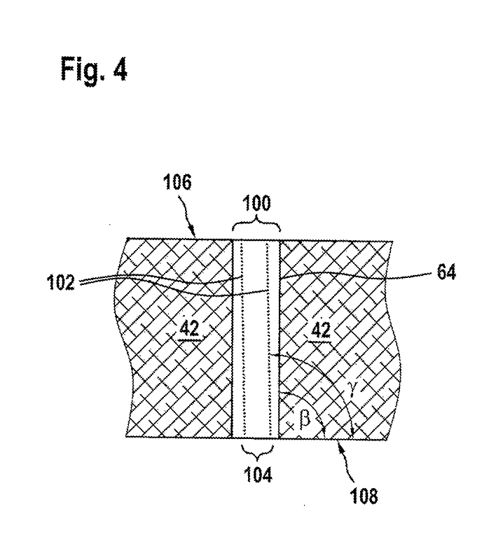

FIG. 4 shows the sawing passage 64 from FIG. 2, which is produced in the workpiece 42 of FIGS. 1 and 2 by means of the semi-autonomous jig saw 11 from FIG. 1. Said sawing passage 64, in an illustrative manner, disposes of a width 100. For comparison, a further sawing passage 102, which is configured when a customary, hand-guided and optionally semi-autonomous jig saw—but without an active free-cutting unit—is used, is drawn having dotted lines, that is to say a jig saw which does not dispose of the electromechanical actuating system 62 from FIG. 1 for periodically pivoting the saw blade 38 in an oscillating manner for free cutting the latter in the workpiece 42. Accordingly, an exemplary width 104 of the sawing passage 102, which is generated with the customary jig saw, turns out to be smaller than the width 100 of the sawing passage 64 which has been introduced into the workpiece 42 by means of the jig saw 11 according to the disclosure, from FIG. 1.

A further significant advantage of the hand-guided, semi-autonomous jig saw 11 from FIG. 1, according to the disclosure, is that the sawing passage 64 precisely encloses an angle β of 90° with an upper and a lower side 106, 108 of the workpiece 42, while the sawing passage 102 generated with the customary jig saw runs in an undesirably oblique manner in relation to the upper and lower sides 106, 108, that is to say encloses an angle γ with the latter which is different from 90°. The jig saw 11 according to the disclosure, from FIG. 1, thus permits in a simple way and manner the production of a sawing passage 64 and/or a sawing cut which runs in a precisely rectangular manner to the upper and lower sides 106, 108.

Therefore, with the hand-guided, semi-autonomous jig saw according to the disclosure, the precision of sawing cuts and/or sawing passages can be significantly increased in comparison to customary jig saws. In comparison to saw blades having set sawing teeth in the customary manner, on account of the employment of the jig saw according to the disclosure, the additional advantage that the free-cutting effect is independent of any potential operational wear of the saw blade is derived, and jamming of said saw blade in the workpiece to be worked is reliably and permanently excluded. As a further positive effect, the increased width, in particular in the case of sawing passages running with a curvature with at least in portions small radii of curvature, enables easier “inward turning” of the jig saw and/or the saw blade within the workpiece 42.

What is claimed is:

1. A hand-guided jig saw, comprising:
a tool receptacle having a vertical axis configured to receive a saw blade;
a reciprocating unit connected to the tool receptacle;
a tool housing that includes a drive motor configured to drive a reciprocating transmission, the reciprocating transmission being configured to drive the reciprocating unit; and
an electromechanical actuating system configured to pivot the tool receptacle by a predefined angle about the vertical axis for at least partial free cutting with the saw blade for forming a sawing passage in a workpiece, wherein pivoting movement of the saw blade is superimposed by at least reciprocating movement of the tool receptacle.

2. The hand-guided jig saw according to claim 1, wherein the electromechanical actuating system is further configured to generate a symmetrically oscillating pivoting movement of the saw blade.

3. The hand-guided jig saw according to claim 1, wherein the electromechanical actuating system is further configured to generate an asymmetrically oscillating pivoting movement of the saw blade.

4. The hand-guided jig saw according to claim 2, wherein the predefined angle is variable with reference to a local amount of curvature of the sawing passage to be produced.

5. The hand-guided jig saw according to claim 1, wherein the predefined angle is predefined with reference to a material of the workpiece.

6. The hand-guided jig saw according to claim 1, wherein the predefined angle is predefined with reference to a feeding rate of the saw blade.

7. The hand-guided jig saw according to claim 1, wherein a frequency of the pivoting movement is preselected.

8. The hand-guided jig saw according to claim 1, wherein the electromechanical actuating system includes an electric servomotor configured to pivot the tool receptacle about the vertical axis.

9. The hand-guided jig saw according to claim 1, wherein the saw blade includes set teeth.

10. The hand-guided jig saw according to claim 1, wherein:
the hand-guided jig saw is a semi-autonomous jig saw that further comprises an optoelectronic system;
the tool receptacle, in response to a signal of the optoelectronic system, is further configured to:
pivot, via the electromechanical actuating system, about the vertical axis within an angular range with reference to an assigned profile of the sawing passage, and
align the saw blade in a self-acting manner when sawing along a pre-drawn marking line, and
the pivoting movement of the tool receptacle is superimposed on the pivoting movement of the saw blade for free cutting with the saw blade.

11. The hand-guided jig saw according to claim 3, wherein the predefined angle is variable with reference to a local amount of curvature of the sawing passage to be produced.
